(19) United States
(12) Patent Application Publication
(10) Pub. No.: US 2014/0371070 A1
(43) Pub. Date: Dec. 18, 2014

(54) PLANT GROWTH REGULATING COMPOUNDS

(71) Applicant: Syngenta Participations AG, Basel (CH)

(72) Inventors: Pierre Joseph Marcel Jung, Stein (CH); Joerg Leipner, Stein (CH); Mathilde Denise Lachia, Stein (CH); Alain De Mesmaeker, Stein (CH)

(73) Assignee: Syngenta Participations AG, Basel (CH)

(21) Appl. No.: 14/363,817

(22) PCT Filed: Dec. 13, 2012
(86) PCT No.: PCT/EP2012/075462

§ 371 Date: Jun. 9, 2014

(30) Foreign Application Priority Data
Dec. 14, 2011 (GB) 1121539.9

(51) Int. Cl. A01N 43/40; A01N 43/56

(52) U.S. Cl. CPC A01N 43/40; A01N 43/56
USPC 504/130; 546/309; 504/260; 546/283.7; 504/251; 546/275.4; 504/253

(57) ABSTRACT

The present invention relates to novel non-steroidal brassinosteroid mimetic derivatives of formula (I), to processes and intermediates for preparing them, to plant growth regulator compositions comprising them and to methods of using them for controlling the growth of plants and/or promoting the germination of seeds.

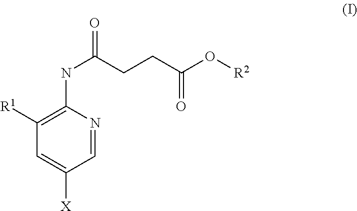

The present invention relates to novel non-steroidal brassinosteroid mimetic derivatives, to processes and intermediates for preparing them, to plant growth regulator compositions comprising them and to methods of using them for controlling the growth of plants and/or promoting the germination of seeds.

Various chemical derivatives that act on the brassinosteroid signalling pathway have been described, for example, in Bioorg. Med. Chem. (1998), 6, p. 1975; Bioorg. Med. Chem. Let. (1999), 9, p. 425; J. Agric. Food Chem. (2002), 50, p. 3486; Planta (2001), 213, p. 716; WO2008/049729, WO2009/109570 and Chemistry & Biology (2009), 16, p. 594-604. Brassinosteroids and analogs thereof have been described to have useful plant growth regulating properties.

It has now surprisingly been found that certain new non-steroidal brassinosteroid mimetic derivatives have properties that are useful for controlling the growth of plants and/or promoting the germination of seeds. Preferably, the new compounds may result in improved plant growth properties, such as faster growth, faster germination, earlier germination and/or reduced toxicity. The compounds may offer other advantages such as enhanced solubility, or be more advantageously formulated, provide more efficient delivery to the plant, provide improved uptake into the plant, or be more readily biodegradable.

According to the present invention, there is provided a compound of Formula (I)

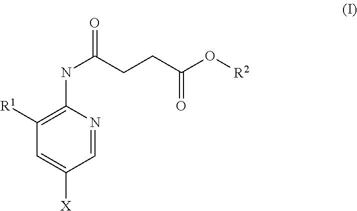

wherein
R¹ is H, C₁-C₂alkyl, C₂alkyl substituted by one or more halogen, hydroxyl or amine;
X is halogen;
R² is C₄-C₉alkyl;
C₄-C₉alkyl substituted by one or more halogen, hydroxyl or amine;
methyl substituted by one or more halogen;
C₂-C₃alkyl substituted by more than two halogens;
C₁-C₉alkyl substituted by one or more of the following: cyano, nitro, C₁-C₆alkoxy, C₁-C₆halo-alkoxy, C₁-C₆alkylthio, C₁-C₆haloalkylthio, C₁-C₆alkylsulfinyl, C₁-C₆haloalkylsulfinyl, C₁-C₆alkylsulfonyl, C₁-C₆haloalkylsulfonyl, C₂-C₆alkenyl, C₂-C₆haloalkenyl, C₂-C₆alkynyl, C₂-C₆haloalkynyl, C₃-C₆cycloalkyl, C₄-C₆alkylcycloalkyl, aryl, aryl substituted by one to five substituents R³, heteroaryl, heteroaryl substituted by one to five substituents R³, heterocyclyl, or heterocyclyl substituted by one to five substituents R³;
C₃-C₇cycloalkyl or C₃-C₇cycloalkyl substituted by one to five substituents R⁴;
aryl or aryl substituted by one to five substituents R³;
heteroaryl or heteroaryl substituted by one to five substituents R³; or
heterocyclyl or heterocyclyl substituted by one to five substituents R³;
each R³ is independently cyano, nitro, amino, hydroxy, halogen, C₁-C₆alkyl, C₁-C₆haloalkyl, C₁-C₄alkoxy-C₁-C₄-alkyl, C₂-C₆alkenyl, C₂-C₆haloalkenyl, C₂-C₆alkynyl, C₂-C₆haloalkynyl, C₃-C₆cycloalkyl, C₃-C₆halocycloalkyl, C₁-C₆alkoxy, C₁-C₆haloalkoxy, C₁-C₄alkoxy-C₁-C₄-alkoxy, C₁-C₆alkylthio, C₁-C₆haloalkylthio, C₁-C₆alkylsulfinyl, C₁-C₆haloalkylsulfinyl, C₁-C₆alkylsulfonyl, C₁-C₆haloalkylsulfonyl, N—C₁-C₆alkylamino, N,N-di-(C₁-C₆alkyl)amino, N,N-di-(C₁-C₆alkyl)aminocarbonyl, N,N-di-(C₁-C₆alkyl)aminosulfonyl, C₁-C₆alkylcarbonyl, C₁-C₆alkylcarbonyloxy, C₁-C₆alkoxycarbonyl, or C₁-C₆alkylcarbonylamino; and
each R⁴ is independently cyano, halogen, C₁-C₄alkyl, C₁-C₄haloalkyl, C₁-C₄alkoxy, or C₁-C₄alkylthio;
or salts or N-oxides thereof.

The compounds of Formula (I) may exist in different geometric or optical isomers (diastereoisomers and enantiomers) or tautomeric forms. This invention covers all such isomers and tautomers and mixtures thereof in all proportions as well as isotopic forms such as deuterated compounds. The invention also covers all salts, N-oxides, and metalloidic complexes of the compounds of Formula (I).

Each alkyl moiety either alone or as part of a larger group (such as alkoxy, alkoxy-carbonyl, alkylcarbonyl, alkylaminocarbonyl, dialkylaminocarbonyl) is a straight or branched chain and is, for example, methyl, ethyl, n-propyl, n-butyl, n-pentyl, n-hexyl, iso-propyl, n-butyl, sec-butyl, iso-butyl, tert-butyl or neo-pentyl. The alkyl groups are preferably C₁ to C₆ alkyl groups, more preferably C₁-C₄ and most preferably C₁-C₃ alkyl groups.

Each alkenyl moiety either alone or as part of a larger group (such as alkoxy, alkoxy-carbonyl, alkylcarbonyl, alkylaminocarbonyl, dialkylaminocarbonyl) is having at least one carbon-carbon double bond and is, for example, vinyl, allyl. The alkenyl groups are preferably C₂ to C₆alkenyl groups, more preferably C₁-C₄alkenyl groups and most preferably C₂-C₄alkenyl groups.

Each alkynyl moiety either alone or as part of a larger group (such as alkoxy, alkoxy-carbonyl, alkylcarbonyl, alkylaminocarbonyl, dialkylaminocarbonyl) is having at least one carbon-carbon triple bond and is, for example, ethynyl, propargyl. The alkynyl groups are preferably C₂ to C₆alkynyl groups, more preferably C₁-C₄alkynyl groups and most preferably C₂-C₄alkynyl groups. The term “alkynyl”, as used herein, unless otherwise indicated, includes alkyl moieties having at least one carbon-carbon triple bond wherein alkyl is as defined above.

Halogen is fluorine, chlorine, bromine or iodine.

Haloalkyl groups (either alone or as part of a larger group, such as haloalkoxy or haloalkylthio) are alkyl groups which are substituted with one or more of the same or different halogen atoms and are, for example, —CF₃, —CF₂Cl, —CH₂CF₃ or —CH₂CHF₂.

Hydroxyalkyl groups are alkyl groups which are substituted with one or more hydroxyl group and are, for example, —CH₂OH, —CH₂CH₂OH or —CH(OH)CH₃.

In the context of the present specification the term “aryl” refers to a ring system which may be mono-, bi- or tricyclic. Examples of such rings include phenyl, naphthalenyl, anthracenyl, indenyl or phenanthrenyl. A preferred aryl group is phenyl.

Unless otherwise indicated, alkenyl and alkynyl, on their own or as part of another substituent, may be straight or branched chain and may preferably contain 2 to 6 carbon atoms, preferably 2 to 4, more preferably 2 to 3, and where appropriate, may be in either the (E)- or (Z)-configuration. Examples include vinyl, allyl and propargyl.

Unless otherwise indicated, cycloalkyl may be mono- or bi-cyclic, may be optionally substituted by one or more C₁-C₆alkyl groups, and preferably contain 3 to 7 carbon atoms, more preferably 3 to 6 carbon atoms. Examples of cycloalkyl include cyclopropyl, 1-methylcyclopropyl, 2-methylcyclopropyl, cyclobutyl, cyclopentyl and cyclohexyl.

The term “heteroaryl” refers to an aromatic ring system containing at least one heteroatom and consisting either of a single ring or of two or more fused rings. Preferably, single rings will contain up to three and bicyclic systems up to four heteroatoms which will preferably be chosen from nitrogen, oxygen and sulfur. Examples of such groups include pyridyl, pyridazinyl, pyrimidinyl, pyrazinyl, furanyl, thiophenyl, oxazolyl, isoxazolyl, oxadiazolyl, thiazolyl, isothiazolyl, thiadiazolyl, pyrrolyl, pyrazolyl, imidazolyl, triazolyl and tetrazolyl. A preferred heteroaryl group is pyridine.

The term “heterocyclyl” is defined to include heteroaryl, saturated analogs, and in addition their unsaturated or partially unsaturated analogues such as 4,5,6,7-tetrahydro-benzothiophenyl, 9H-fluorenyl, 3,4-dihydro-2H-benzo-1,4-dioxepinyl, 2,3-dihydro-benzo-furanyl, piperidinyl, 1,3-dioxolanyl, 1,3-dioxanyl, 4,5-dihydro-isoxazolyl, tetrahydrofuranyl and morpholinyl. In addition, the term “heterocyclyl” is defined to include “heterocycloalkyl” defined to be a non-aromatic monocyclic or polycyclic ring comprising carbon and hydrogen atoms and at least one heteroatom, preferably, 1 to 4 heteroatoms selected from nitrogen, oxygen, and sulfur such as oxirane or thietane.

Preferred values of R¹, R² and X of the compound of Formula (I) are, in any combination, as set out below:

R¹ is H, or methyl;

### X is Cl, Br or I;

R² is C₄-C₉alkyl;
C₄-C₉alkyl substituted by one or more halogen, hydroxyl or amine;
or C₁-C₉alkyl substituted by one or more of the following: cyano, C₁-C₆alkoxy, C₁-C₆alkylthio, C₂-C₆ alkenyl, C₂-C₆alkynyl, C₁-C₆alkylsulfinyl, C₁-C₆alkylsulfonyl, C₃-C₆cycloalkyl, C₄-C₆alkylcycloalkyl, aryl, aryl substituted by one to five substituents R³, heteroaryl, heteroaryl substituted by one to five substituents R³, heterocyclyl, or heterocyclyl substituted by one to five substituents R³.
More preferably, R² is C₄-C₉alkyl;
C₄-C₉alkyl substituted by one or more halogen, hydroxyl or amine;
or C₁-C₉alkyl substituted by C₁-C₆alkoxy, C₁-C₆alkylthio, C₂-C₆ alkenyl, or C₂-C₆alkynyl.
In one embodiment, R¹ is H. In a further embodiment, R¹ is methyl.
In one embodiment X is Cl. In a further embodiment, X is Br. In a further embodiment, X is I.
In one embodiment, R² is C₄-C₉alkyl. In another embodiment, R² is C₄-C₉alkyl substituted by one or more halogen, hydroxyl or amine. In a further embodiment, R² is C₁-C₉alkyl substituted by C₁-C₆alkoxy, C₁-C₆alkylthio, C₂-C₆ alkenyl, or C₂-C₆alkynyl.
Table 1 below includes examples of compounds of Formula (I) wherein R₁, R₂ and X are as defined.

TABLE 1
(I)

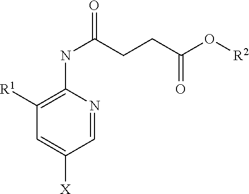

| Compound | X | R¹ | R² |
|---|---|---|---|
| 1.00 | Cl | H | CH₂CCH |
| 1.01 | Cl | H | CH₂CHCH₂ |
| 1.02 | Cl | H | n-C₄H₉ |
| 1.03 | Cl | H | tert-C₄H₉ |
| 1.04 | Cl | H | sec-C₄H₉ |
| 1.05 | Cl | H | iso-C₄H₉ |
| 1.06 | Cl | H | CH₂CN |
| 1.07 | Cl | H | CH₂CH₂CN |
| 1.08 | Cl | H | CH₂CH₂Ph |
| 1.09 | Cl | H | CH₂(4-Py) |
| 1.10 | Cl | H | CH₂Ph |
| 1.11 | Cl | H | CH₂CH(CH₂)₂ |
| 1.12 | Cl | H | CH₂OCH₃ |
| 1.13 | Cl | H | CH₂CH₂OCH₃ |
| 1.14 | Cl | H | CH₂CH(—CH₂—O—) |
| 1.15 | Cl | H | CH(CH₂)₂ |
| 1.16 | Cl | H | CH(CH₂)₃ |
| 1.17 | Cl | H | CH(—CH₂—CH₂—O—) |
| 1.18 | Cl | H | CH₂CH₂SCH₃ |
| 1.19 | Cl | H | CH₂CH(CH₂)₄ |
| 1.20 | Cl | CH₃ | CH₂CCH |
| 1.21 | Cl | CH₃ | CH₂CHCH₂ |
| 1.22 | Cl | CH₃ | n-C₄H₉ |
| 1.23 | Cl | CH₃ | tert-C₄H₉ |
| 1.24 | Cl | CH₃ | sec-C₄H₉ |
| 1.25 | Cl | CH₃ | iso-C₄H₉ |
| 1.26 | Cl | CH₃ | CH₂CN |
| 1.27 | Cl | CH₃ | CH₂CH₂CN |
| 1.28 | Cl | CH₃ | CH₂CH₂Ph |
| 1.29 | Cl | CH₃ | CH₂(4-Py) |
| 1.30 | Cl | CH₃ | CH₂Ph |
| 1.31 | Cl | CH₃ | CH₂CH(CH₂)₂ |
| 1.32 | Cl | CH₃ | CH₂OCH₃ |
| 1.33 | Cl | CH₃ | CH₂CH₂OCH₃ |
| 1.34 | Cl | CH₃ | CH₂CH(—CH₂—O—) |
| 1.35 | Cl | CH₃ | CH(CH₂)₂ |
| 1.36 | Cl | CH₃ | CH(CH₂)₃ |
| 1.37 | Cl | CH₃ | CH(—CH₂—CH₂—O—) |
| 1.38 | Cl | CH₃ | CH₂CH₂SCH₃ |
| 1.39 | Cl | CH₃ | CH₂CH(CH₂)₄ |
| 1.40 | Br | H | CH₂CCH |
| 1.41 | Br | H | CH₂CHCH₂ |
| 1.42 | Br | H | n-C₄H₉ |
| 1.43 | Br | H | tert-C₄H₉ |
| 1.44 | Br | H | sec-C₄H₉ |
| 1.45 | Br | H | iso-C₄H₉ |
| 1.46 | Br | H | CH₂CN |
| 1.47 | Br | H | CH₂CH₂CN |
| 1.48 | Br | H | CH₂CH₂Ph |
| 1.49 | Br | H | CH₂(4-Py) |
| 1.50 | Br | H | CH₂Ph |
| 1.51 | Br | H | CH₂CH(CH₂)₂ |
| 1.52 | Br | H | CH₂OCH₃ |
| 1.53 | Br | H | CH₂CH₂OCH₃ |
| 1.54 | Br | H | CH₂CH(—CH₂—O—) |
| 1.55 | Br | H | CH(CH₂)₂ |
| 1.56 | Br | H | CH(CH₂)₃ |
| 1.57 | Br | H | CH(—CH₂—CH₂—O—) |
| 1.58 | Br | H | CH₂CH₂SCH₃ |
| 1.59 | Br | H | CH₂CH(CH₂)₄ |
| 1.60 | Br | CH₃ | CH₂CCH |
| 1.61 | Br | CH₃ | CH₂CHCH₂ |
| 1.62 | Br | CH₃ | n-C₄H₉ |
| 1.63 | Br | CH₃ | tert-C₄H₉ |
| 1.64 | Br | CH₃ | sec-C₄H₉ |
| 1.65 | Br | CH₃ | iso-C₄H₉ |
| 1.66 | Br | CH₃ | CH₂CN |
| 1.67 | Br | CH₃ | CH₂CH₂CN |
| 1.68 | Br | CH₃ | CH₂CH₂Ph |
| 1.69 | Br | CH₃ | CH₂(4-Py) |
| 1.70 | Br | CH₃ | CH₂Ph |
| 1.71 | Br | CH₃ | CH₂CH(CH₂)₂ |
| 1.72 | Br | CH₃ | CH₂OCH₃ |
| 1.73 | Br | CH₃ | CH₂CH₂OCH₃ |
| 1.74 | Br | CH₃ | CH₂CH(—CH₂—O—) |
| 1.75 | Br | CH₃ | CH(CH₂)₂ |
| 1.76 | Br | CH₃ | CH(CH₂)₃ |
| 1.77 | Br | CH₃ | CH(—CH₂—CH₂—O—) |
| 1.78 | Br | CH₃ | CH₂CH₂SCH₃ |
| 1.79 | Br | CH₃ | CH₂CH(CH₂)₄ |
| 1.80 | I | H | CH₂CCH |
| 1.81 | I | H | CH₂CHCH₂ |
| 1.82 | I | H | n-C₄H₉ |
| 1.83 | I | H | tert-C₄H₉ |
| 1.84 | I | H | sec-C₄H₉ |
| 1.85 | I | H | iso-C₄H₉ |
| 1.86 | I | H | CH₂CN |
| 1.87 | I | H | CH₂CH₂CN |
| 1.88 | I | H | CH₂CH₂Ph |
| 1.89 | I | H | CH₂(4-Py) |
| 1.90 | I | H | CH₂Ph |
| 1.91 | I | H | CH₂CH(CH₂)₂ |
| 1.92 | I | H | CH₂OCH₃ |
| 1.93 | I | H | CH₂CH₂OCH₃ |
| 1.94 | I | H | CH₂CH(—CH₂—O—) |
| 1.95 | I | H | CH(CH₂)₂ |
| 1.96 | I | H | CH(CH₂)₃ |
| 1.97 | I | H | CH(—CH₂—CH₂—O—) |
| 1.98 | I | H | CH₂CH₂SCH₃ |
| 1.99 | I | H | CH₂CH(CH₂)₄ |
| 2.00 | I | CH₃ | CH₂CCH |
| 2.01 | I | CH₃ | CH₂CHCH₂ |
| 2.02 | I | CH₃ | n-C₄H₉ |
| 2.03 | I | CH₃ | tert-C₄H₉ |
| 2.04 | I | CH₃ | sec-C₄H₉ |
| 2.05 | I | CH₃ | iso-C₄H₉ |
| 2.06 | I | CH₃ | CH₂CN |
| 2.07 | I | CH₃ | CH₂CH₂CN |
| 2.08 | I | CH₃ | CH₂CH₂Ph |
| 2.09 | I | CH₃ | CH₂(4-Py) |
| 2.10 | I | CH₃ | CH₂Ph |
| 2.11 | I | CH₃ | CH₂CH(CH₂)₂ |
| 2.12 | I | CH₃ | CH₂OCH₃ |
| 2.13 | I | CH₃ | CH₂CH₂OCH₃ |
| 2.14 | I | CH₃ | CH₂CH(—CH₂—O—) |
| 2.15 | I | CH₃ | CH(CH₂)₂ |
| 2.16 | I | CH₃ | CH(CH₂)₃ |
| 2.17 | I | CH₃ | CH(—CH₂—CH₂—O—) |
| 2.18 | I | CH₃ | CH₂CH₂SCH₃ |
| 2.19 | I | CH₃ | CH₂CH(CH₂)₄ |

The compounds of Formula (I) according to the invention can be used as plant growth regulators or seed germination promoters by themselves, but they are generally Formulated into plant growth regulation or seed germination promotion compositions using Formulation adjuvants, such as carriers, solvents and surface-active agents (SFAs). Thus, the present invention further provides a plant growth regulator composition comprising a plant growth regulation compound as described herein and an agriculturally acceptable Formulation adjuvant or carrier. The present invention further provides a seed germination promoter composition comprising a seed germination promoter compound as described herein and an agriculturally acceptable Formulation adjuvant or carrier. Preferably the composition consists essentially of a compound of Formula (I) and an agriculturally acceptable Formulation adjuvant or carrier. In the alternative, the composition consists of a compound of Formula (I) and at least one agriculturally acceptable Formulation adjuvant or carrier. In one embodiment, the present invention provides a composition comprising a compound of Formula (I) and an agriculturally acceptable carrier, wherein in Formula (I)

R¹ is H, C₁-C₂alkyl, C₂alkyl substituted by one or more halogen, hydroxyl or amine;
X is halogen;
R² is C₄-C₉alkyl; C₄-C₉alkyl substituted by one or more halogen, hydroxyl or amine;
methyl substituted by one or more halogen; C₂-C₃alkyl substituted by more than two halogens; C₁-C₉alkyl substituted by one or more of the following: cyano, nitro, C₁-C₆alkoxy, C₁-C₆haloalkoxy, C₁-C₆alkylthio, C₁-C₆haloalkylthio, C₁-C₆alkylsulfinyl, C₁-C₆haloalkyl-sulfinyl, C₁-C₆alkylsulfonyl, C₁-C₆haloalkylsulfonyl, C₂-C₆alkenyl, C₂-C₆haloalkenyl, C₂-C₆alkynyl, C₂-C₆haloalkynyl, C₃-C₆cycloalkyl, C₄-C₆alkylcycloalkyl, aryl, aryl substituted by one to five substituents R³, heteroaryl, heteroaryl substituted by one to five substituents R³, heterocyclyl, or heterocyclyl substituted by one to five substituents R³; C₃-C₇cycloalkyl or C₃-C₇cycloalkyl substituted by one to five substituents R⁴; aryl or aryl substituted by one to five substituents R³; heteroaryl or heteroaryl substituted by one to five substituents R³; or heterocyclyl or heterocyclyl substituted by one to five substituents R³;
each R³ is independently cyano, nitro, amino, hydroxy, halogen, C₁-C₆alkyl, C₁-C₆haloalkyl, C₁-C₄alkoxy-C₁-C₄-alkyl, C₂-C₆alkenyl, C₂-C₆haloalkenyl, C₂-C₆alkynyl, C₂-C₆haloalkynyl, C₃-C₆cycloalkyl, C₃-C₆halocycloalkyl, C₁-C₆alkoxy, C₁-C₆haloalkoxy, C₁-C₄alkoxy-C₁-C₄-alkoxy, C₁-C₆alkylthio, C₁-C₆haloalkylthio, C₁-C₆alkylsulfinyl, C₁-C₆haloalkylsulfinyl, C₁-C₆alkylsulfonyl, C₁-C₆haloalkylsulfonyl, N—C₁-C₆alkylamino, N,N-di-(C₁-C₆alkyl)amino, N,N-di-(C₁-C₆alkyl)aminocarbonyl, N,N-di-(C₁-C₆alkyl)aminosulfonyl, C₁-C₆alkylcarbonyl, C₁-C₆alkylcarbonyloxy, C₁-C₆alkoxycarbonyl, or C₁-C₆alkylcarbonylamino; and
each R⁴ is independently cyano, halogen, C₁-C₄alkyl, C₁-C₄haloalkyl, C₁-C₄alkoxy, or C₁-C₄alkylthio;
or salts or N-oxides thereof.

In a further embodiment, the present invention provides a composition comprising a compound of Formula (I) and an agriculturally acceptable carrier, wherein in Formula (I);

R¹ is H, or methyl;

### X is Cl, Br or I;

R² is C₄-C₉alkyl; C₄-C₉alkyl substituted by one or more halogen, hydroxyl or amine; or C₁-C₉alkyl substituted by one or more of the following: cyano, C₁-C₆alkoxy, C₁-C₆alkylthio, C₂-C₆ alkenyl, C₂-C₆alkynyl, C₁-C₆alkylsulfinyl, C₁-C₆alkylsulfonyl, C₃-C₆cycloalkyl, C₄-C₆alkylcycloalkyl, aryl, aryl substituted by one to five substituents R³, heteroaryl, heteroaryl substituted by one to five substituents R³, heterocyclyl, or heterocyclyl substituted by one to five substituents R³; and
each R³ is independently cyano, nitro, amino, hydroxy, halogen, C₁-C₆alkyl, C₁-C₆haloalkyl, C₁-C₄alkoxy-C₁-C₄-alkyl, C₂-C₆alkenyl, C₂-C₆haloalkenyl, C₂-C₆alkynyl, C₂-C₆haloalkynyl, C₃-C₆cycloalkyl, C₃-C₆halocycloalkyl, C₁-C₆alkoxy, C₁-C₆haloalkoxy, C₁-C₄alkoxy-C₁-C₄-alkoxy, C₁-C₆alkylthio, C₁-C₆haloalkylthio, C₁-C₆alkylsulfinyl, C₁-C₆haloalkylsulfinyl, C₁-C₆alkylsulfonyl, C₁-C₆haloalkylsulfonyl, N—C₁-C₆alkylamino, N,N-di-(C₁-C₆alkyl)amino, N,N-di-(C₁-C₆alkyl)aminocarbonyl, N,N-di-(C₁-C₆alkyl)aminosulfonyl, C₁-C₆alkylcarbonyl, C₁-C₆alkylcarbonyloxy, C₁-C₆alkoxycarbonyl, or C₁-C₆alkylcarbonylamino.

The composition can be in the form of concentrates which are diluted prior to use, although ready-to-use compositions can also be made. The final dilution is usually made with water, but can be made instead of, or in addition to, water, with, for example, liquid fertilisers, micronutrients, biological organisms, oil or solvents.

The compositions generally comprise from 0.1 to 99% by weight, especially from 0.1 to 95% by weight, compounds of Formula I and from 1 to 99.9% by weight of a formulation adjuvant which preferably includes from 0 to 25% by weight of a surface-active substance.

The compositions can be chosen from a number of formulation types, many of which are known from the Manual on Development and Use of FAO Specifications for Plant Protection Products, 5th Edition, 1999. These include dustable powders (DP), soluble powders (SP), water soluble granules (SG), water dispersible granules (WG), wettable powders (WP), granules (GR) (slow or fast release), soluble concentrates (SL), oil miscible liquids (OL), ultra low volume liquids (UL), emulsifiable concentrates (EC), dispersible concentrates (DC), emulsions (both oil in water (EW) and water in oil (EO)), micro-emulsions (ME), suspension concentrates (SC), aerosols, capsule suspensions (CS) and seed treatment Formulations. The formulation type chosen in any instance will depend upon the particular purpose envisaged and the physical, chemical and biological properties of the compound of Formula (I).

Dustable powders (DP) may be prepared by mixing a compound of Formula (I) with one or more solid diluents (for example natural clays, kaolin, pyrophyllite, bentonite, alumina, montmorillonite, kieselguhr, chalk, diatomaceous earths, calcium phosphates, calcium and magnesium carbonates, sulphur, lime, flours, talc and other organic and inorganic solid carriers) and mechanically grinding the mixture to a fine powder.

Soluble powders (SP) may be prepared by mixing a compound of Formula (I) with one or more water-soluble inorganic salts (such as sodium bicarbonate, sodium carbonate or magnesium sulphate) or one or more water-soluble organic solids (such as a polysaccharide) and, optionally, one or more wetting agents, one or more dispersing agents or a mixture of said agents to improve water dispersibility/solubility. The mixture is then ground to a fine powder. Similar compositions may also be granulated to form water soluble granules (SG).

Wettable powders (WP) may be prepared by mixing a compound of Formula (I) with one or more solid diluents or carriers, one or more wetting agents and, preferably, one or more dispersing agents and, optionally, one or more suspending agents to facilitate the dispersion in liquids. The mixture is then ground to a fine powder. Similar compositions may also be granulated to form water dispersible granules (WG).

Granules (GR) may be formed either by granulating a mixture of a compound of Formula (I) and one or more powdered solid diluents or carriers, or from pre-formed blank granules by absorbing a compound of Formula (I) (or a solution thereof, in a suitable agent) in a porous granular material (such as pumice, attapulgite clays, fuller's earth, kieselguhr, diatomaceous earths or ground corn cobs) or by adsorbing a compound of Formula (I) (or a solution thereof, in a suitable agent) on to a hard core material (such as sands, silicates, mineral carbonates, sulphates or phosphates) and drying if necessary. Agents which are commonly used to aid absorption or adsorption include solvents (such as aliphatic and aromatic petroleum solvents, alcohols, ethers, ketones and esters) and sticking agents (such as polyvinyl acetates, polyvinyl alcohols, dextrins, sugars and vegetable oils). One or more other additives may also be included in granules (for example an emulsifying agent, wetting agent or dispersing agent).

Dispersible Concentrates (DC) may be prepared by dissolving a compound of Formula (I) in water or an organic solvent, such as a ketone, alcohol or glycol ether. These solutions may contain a surface active agent (for example to improve water dilution or prevent crystallisation in a spray tank).

Emulsifiable concentrates (EC) or oil-in-water emulsions (EW) may be prepared by dissolving a compound of Formula (I) in an organic solvent (optionally containing one or more wetting agents, one or more emulsifying agents or a mixture of said agents). Suitable organic solvents for use in ECs include aromatic hydrocarbons (such as alkylbenzenes or alkylnaphthalenes, exemplified by SOLVESSO 100, SOLVESSO 150 and SOLVESSO 200; SOLVESSO is a Registered Trade Mark), ketones (such as cyclohexanone or methylcyclohexanone) and alcohols (such as benzyl alcohol, furfuryl alcohol or butanol), N-alkylpyrrolidones (such as N-methylpyrrolidone or N-octylpyrrolidone), dimethyl amides of fatty acids (such as C₈-C₁₀ fatty acid dimethylamide) and chlorinated hydrocarbons. An EC product may spontaneously emulsify on addition to water, to produce an emulsion with sufficient stability to allow spray application through appropriate equipment.

Preparation of an EW involves obtaining a compound of Formula (I) either as a liquid (if it is not a liquid at room temperature, it may be melted at a reasonable temperature, typically below 70° C.) or in solution (by dissolving it in an appropriate solvent) and then emulsifying the resultant liquid or solution into water containing one or more SFAs, under high shear, to produce an emulsion. Suitable solvents for use in EWs include vegetable oils, chlorinated hydrocarbons (such as chlorobenzenes), aromatic solvents (such as alkylbenzenes or alkylnaphthalenes) and other appropriate organic solvents which have a low solubility in water.

Microemulsions (ME) may be prepared by mixing water with a blend of one or more solvents with one or more SFAs, to produce spontaneously a thermodynamically stable isotropic liquid Formulation. A compound of Formula (I) is present initially in either the water or the solvent/SFA blend. Suitable solvents for use in MEs include those hereinbefore described for use in ECs or in EWs. An ME may be either an oil-in-water or a water-in-oil system (which system is present may be determined by conductivity measurements) and may be suitable for mixing water-soluble and oil-soluble pesticides in the same Formulation. An ME is suitable for dilution into water, either remaining as a microemulsion or forming a conventional oil-in-water emulsion.

Suspension concentrates (SC) may comprise aqueous or non-aqueous suspensions of finely divided insoluble solid particles of a compound of Formula (I). SCs may be prepared by ball or bead milling the solid compound of Formula (I) in a suitable medium, optionally with one or more dispersing agents, to produce a fine particle suspension of the compound. One or more wetting agents may be included in the composition and a suspending agent may be included to reduce the rate at which the particles settle. Alternatively, a compound of Formula (I) may be dry milled and added to water, containing agents hereinbefore described, to produce the desired end product.

Aerosol Formulations comprise a compound of Formula (I) and a suitable propellant (for example n-butane). A compound of Formula (I) may also be dissolved or dispersed in a suitable medium (for example water or a water miscible liquid, such as n-propanol) to provide compositions for use in non-pressurised, hand-actuated spray pumps.

Capsule suspensions (CS) may be prepared in a manner similar to the preparation of EW Formulations but with an additional polymerisation stage such that an aqueous dispersion of oil droplets is obtained, in which each oil droplet is encapsulated by a polymeric shell and contains a compound of Formula (I) and, optionally, a carrier or diluent therefor. The polymeric shell may be produced by either an interfacial polycondensation reaction or by a coacervation procedure. The compositions may provide for controlled release of the compound of Formula (I) and they may be used for seed treatment. A compound of Formula (I) may also be Formulated in a biodegradable polymeric matrix to provide a slow, controlled release of the compound.

The composition may include one or more additives to improve the biological performance of the composition, for example by improving wetting, retention or distribution on surfaces; resistance to rain on treated surfaces; or uptake or mobility of a compound of Formula (I). Such additives include surface active agents (SFAs), spray additives based on oils, for example certain mineral oils or natural plant oils (such as soy bean and rape seed oil), and blends of these with other bio-enhancing adjuvants (ingredients which may aid or modify the action of a compound of Formula (I)).

Wetting agents, dispersing agents and emulsifying agents may be SFAs of the cationic, anionic, amphoteric or non-ionic type.

Suitable SFAs of the cationic type include quaternary ammonium compounds (for example cetyltrimethyl ammonium bromide), imidazolines and amine salts.

Suitable anionic SFAs include alkali metals salts of fatty acids, salts of aliphatic monoesters of sulphuric acid (for example sodium lauryl sulphate), salts of sulphonated aromatic compounds (for example sodium dodecylbenzenesulphonate, calcium dodecylbenzenesulphonate, butylnaphthalene sulphonate and mixtures of sodium di-isopropyl- and tri-isopropyl-naphthalene sulphonates), ether sulphates, alcohol ether sulphates (for example sodium laureth-3-sulphate), ether carboxylates (for example sodium laureth-3-carboxylate), phosphate esters (products from the reaction between one or more fatty alcohols and phosphoric acid (predominately mono-esters) or phosphorus pentoxide (predominately di-esters), for example the reaction between lauryl alcohol and tetraphosphoric acid; additionally these products may be ethoxylated), sulphosuccinamates, paraffin or olefine sulphonates, taurates and lignosulphonates.

Suitable SFAs of the amphoteric type include betaines, propionates and glycinates.

Suitable SFAs of the non-ionic type include condensation products of alkylene oxides, such as ethylene oxide, propylene oxide, butylene oxide or mixtures thereof, with fatty alcohols (such as oleyl alcohol or cetyl alcohol) or with alkylphenols (such as octylphenol, nonylphenol or octylcresol); partial esters derived from long chain fatty acids or hexitol anhydrides; condensation products of said partial esters with ethylene oxide; block polymers (comprising ethylene oxide and propylene oxide); alkanolamides; simple esters (for example fatty acid polyethylene glycol esters); amine oxides (for example lauryl dimethyl amine oxide); and lecithins.

Suitable suspending agents include hydrophilic colloids (such as polysaccharides, polyvinylpyrrolidone or sodium carboxymethylcellulose) and swelling clays (such as bentonite or attapulgite).

The present invention still further provides a method for regulating the growth of plants in a locus, wherein the method comprises application to the locus of a plant growth regulating amount of a composition according to the present invention. Preferably the composition is applied by spray application to the leaves of the plant.

The present invention also provides a method for promoting the germination of seeds, comprising applying to the seeds, or to a locus containing seeds, a seed germination promoting amount of a composition according to the present invention.

The application is generally made by spraying the composition, typically by tractor mounted sprayer for large areas, but other methods such as dusting (for powders), drip or drench can also be used. Alternatively the composition may be applied in furrow or directly to a seed before or at the time of planting.

The compound of Formula (I) or composition of the present invention may be applied to a plant, part of the plant, plant organ, plant propagation material or a surrounding area thereof.

In one embodiment, the invention relates to a method of treating a plant propagation material comprising applying to the plant propagation material a composition of the present invention in an amount effective to promote germination and/or regulate plant growth. The invention also relates to a plant propagation material treated with a compound of Formula (I) or a composition of the present invention. Preferably, the plant propagation material is a seed.

The term “plant propagation material” denotes all the generative parts of the plant, such as seeds, which can be used for the multiplication of the latter and vegetative plant materials such as cuttings and tubers. In particular, there may be mentioned the seeds, roots, fruits, tubers, bulbs, and rhizomes.

Methods for applying active ingredients to plant propagation material, especially seeds, are known in the art, and include dressing, coating, pelleting and soaking application methods of the propagation material. The treatment can be applied to the seed at any time between harvest of the seed and sowing of the seed or during the sowing process. The seed may also be primed either before or after the treatment. The compound of Formula (I) may optionally be applied in combination with a controlled release coating or technology so that the compound is released over time.

The composition of the present invention may be applied pre-emergence or post-emergence. Suitably, where the composition is being used to regulate the growth of crop plants, it may be applied pre or post-emergence, but preferably post-emergence of the crop. Where the composition is used to promote the germination of seeds, it may be applied pre-emergence.

The rates of application of compounds of Formula (I) may vary within wide limits and depend on the nature of the soil, the method of application (pre- or post-emergence; seed dressing; application to the seed furrow; no tillage application etc.), the crop plant, the prevailing climatic conditions, and other factors governed by the method of application, the time of application and the target crop. For foliar or drench application, the compounds of Formula I according to the invention are generally applied at a rate of from 0.001 to 2000 g/ha, especially from 0.01 to 400 g/ha. For seed treatment the rate of application is generally between 0.0005 and 150 g per 100 kg of seed.

Plants in which the composition according to the invention can be used include crops such as cereals (for example wheat, barley, rye, oats); beet (for example sugar beet or fodder beet); fruits (for example pomes, stone fruits or soft fruits, such as apples, pears, plums, peaches, almonds, cherries, strawberries, raspberries or blackberries); leguminous plants (for example beans, lentils, peas or soybeans); oil plants (for example rape, mustard, poppy, olives, sunflowers, coconut, castor oil plants, cocoa beans or groundnuts); cucumber plants (for example marrows, cucumbers or melons); fibre plants (for example cotton, flax, hemp or jute); citrus fruit (for example oranges, lemons, grapefruit or mandarins); vegetables (for example spinach, lettuce, asparagus, cabbages, carrots, onions, tomatoes, potatoes, cucurbits or paprika); lauraceae (for example avocados, cinnamon or camphor); maize; rice; tobacco; nuts; coffee; sugar cane; tea; vines; hops; durian; bananas; natural rubber plants; turf or ornamentals (for example flowers, shrubs, broad-leaved trees or evergreens such as conifers). This list does not represent any limitation.

The invention may also be used to regulate the growth, or promote the germination of seeds of non-crop plants, for example to facilitate weed control by synchronizing germination.

Crops are to be understood as also including those crops which have been modified by conventional methods of breeding or by genetic engineering. For example, the invention may be used in conjunction with crops that have been rendered tolerant to herbicides or classes of herbicides (e.g. ALS-, GS-, EPSPS-, PPO-, ACCase- and HPPD-inhibitors). An example of a crop that has been rendered tolerant to imidazolinones, e.g. imazamox, by conventional methods of breeding is Clearfield® summer rape (canola). Examples of crops that have been rendered tolerant to herbicides by genetic engineering methods include e.g. glyphosate- and glufosinate-resistant maize varieties commercially available under the trade names RoundupReady® and LibertyLink®. Methods of rending crop plants tolerant to HPPD-inhibitors are known, for example from WO0246387; for example the crop plant is transgenic in respect of a polynucleotide comprising a DNA sequence which encodes an HPPD-inhibitor resistant HPPD enzyme derived from a bacterium, more particularly from Pseudomonas fluorescens or Shewanella colwelliana, or from a plant, more particularly, derived from a monocot plant or, yet more particularly, from a barley, maize, wheat, rice, Brachiaria, Chenchrus, Lolium, Festuca, Setaria, Eleusine, Sorghum or Avena species.

Crops are also to be understood as being those which have been rendered resistant to harmful insects by genetic engineering methods, for example Bt maize (resistant to European corn borer), Bt cotton (resistant to cotton boll weevil) and also Bt potatoes (resistant to Colorado beetle). Examples of Bt maize are the Bt 176 maize hybrids of NK® (Syngenta Seeds). The Bt toxin is a protein that is formed naturally by Bacillus thuringiensis soil bacteria. Examples of toxins, or transgenic plants able to synthesise such toxins, are described in EP-A-451 878, EP-A-374 753, WO 93/07278, WO 95/34656, WO 03/052073 and EP-A-427 529. Examples of transgenic plants comprising one or more genes that code for an insecticidal resistance and express one or more toxins are KnockOut® (maize), Yield Gard® (maize), NuCOTIN33B® (cotton), Bollgard® (cotton), NewLeaf® (potatoes), NatureGard® and Protexcta®. Plant crops or seed material thereof can be both resistant to herbicides and, at the same time, resistant to insect feeding (“stacked” transgenic events). For example, seed can have the ability to express an insecticidal Cry3 protein while at the same time being tolerant to glyphosate.

Crops are also to be understood to include those which are obtained by conventional methods of breeding or genetic engineering and contain so-called output traits (e.g. improved storage stability, higher nutritional value and improved flavour).

Compounds of the present invention may be in the form of an ester or an acid, either of which may have plant growth regulating properties. As suggested in WO2009/109570, it is thought that the ester form of the compounds of Formula I may be hydrolysed in planta to the acid form. This may be a particular advantage where the esterified compounds are more readily taken up by the plant, without being bound by theory for example through leaf tissue.

Compounds and compositions of the present invention may be applied in combination with other active ingredients or products for use in agriculture, including insecticides, fungicides, herbicides, plant growth regulators, crop enhancing compounds, nutrients and biologicals. Examples of suitable mixing partners may be found in the Pesticide Manual, 15^{th} edition (published by the British Crop Protection Council). Such mixtures may be applied to a plant, plant propagation material or plant growing locus either simultaneously (for example as a pre-formulated mixture or a tank mix), or sequentially in a suitable timescale. Co-application of pesticides with the present invention has the added benefit of minimising farmer time spent applying products to crops.

In a further aspect of the present invention, the compounds or composition of the present invention may be applied in combination with one or more other compounds having a crop enhancement effect. Such compounds include micronutrients, saccharides, amino acids, flavonoids, quinines, and plant activators/growth stimulators. For example, such compounds include natural or synthetic hormones, auxins, brassinosteroids, gibberellins, abscisic acid, cytokinins, jasmonates, strigolactones, salicylic acid, ethylene, 1-methylcyclopropene, trinexapac-ethyl or derivatives thereof. Such compounds also include pesticides that have a crop enhancement effect, for example strobilurins (including azoxystrobin, pyraclostrobin), and neonicotinoids (including thiamethoxam, and imidacloprid).

The compounds of the invention may be made by the following methods.

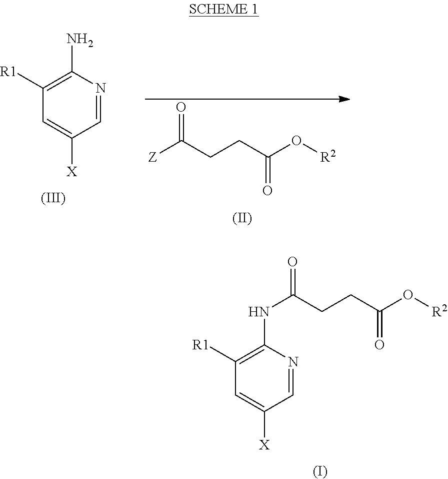

Compounds of Formula (I) may be prepared from a compound of Formula (III) via acylation by reaction of a compounds of Formula (II) within Z is halogen such as chlorine, such reactions are usually carried out in the presence of a base, and optionally in the presence of a nucleophilic catalyst. Alternatively, it is possible to conduct the reaction in a biphasic system comprising an organic solvent, preferably ethyl acetate, and an aqueous solvent, preferably a solution of sodium hydrogen carbonate.
Compounds of Formula (II) are commercially available, such as benzyl succinyl chloride or can be made by methods known to a person skilled in the art.

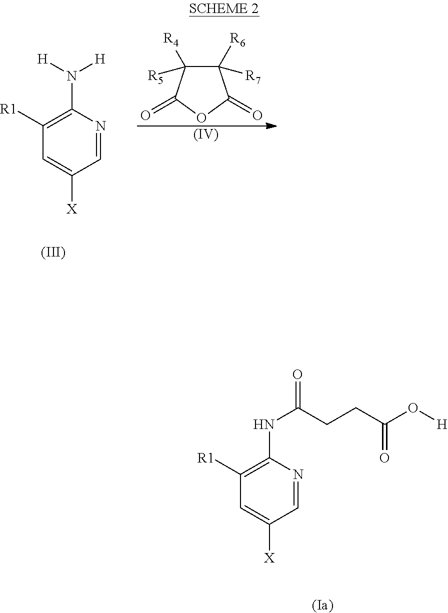

Compounds of Formula (Ia) may be made by treatment of compounds of Formula (III) by treatment with a anhydride derivatives of Formula (IV), such as succinyl anhydride, in a solvent, such as tetrahydrofuran. The reaction is carried out preferably at a temperature of from −20° C. to +120° C., more preferably from 20° C. to 120° C.

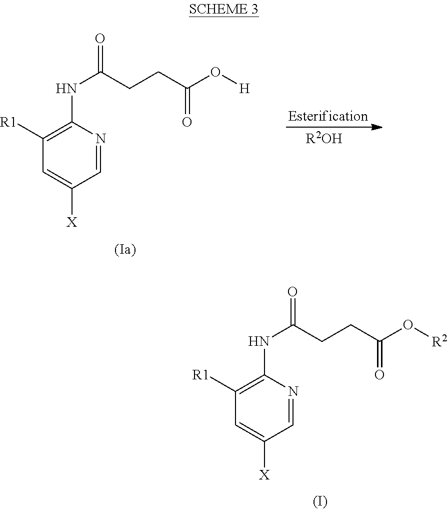

Compounds of Formula (I) may be made by treatment of compounds of Formula (Ia), via esterification in presence of a alcohol derivative (R²OH). The esterification reaction may be carried out under acidic condition such as in presence of sulfuric acid or hydrogen chloride and in a suitable solvent, such as, for example the alcohol derivative (R²OH). Alternatively, this reaction can conveniently be carried out using a coupling method such as, for example Dicyclohexylcarbodiimide. These reactions are known to a person skilled in the art and where reviewed, for example, in “Synthetic Organic Methodology: Comprehensive Organic Transformations. A Guide to Functional Group Preparations.” Larock, R. C. 1989, p. 966-972, Publisher: (VCH, Weinheim, Fed. Rep. Ger.).

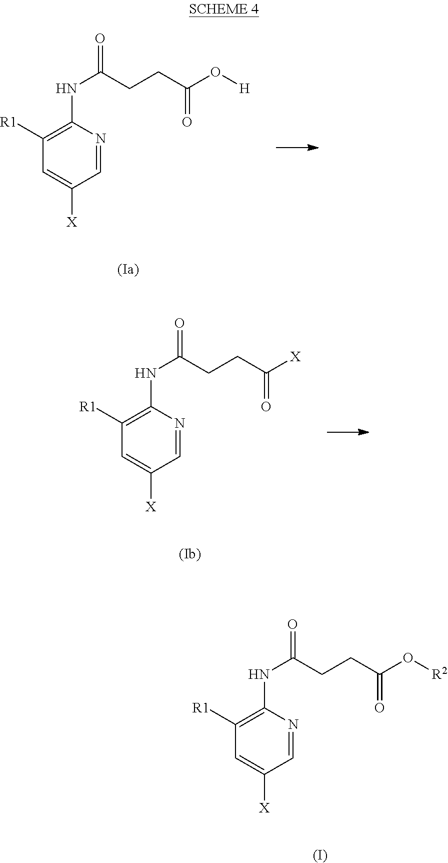

Alternatively, compounds of Formula (I) may be prepared from a compound of Formula (Ib) via acylation reaction to acylate alcohols derivatives to form esters. The acylation reaction may be carried out under basic conditions (for example in the presence of pyridine, triethylamine, 4-(dimethylamino)pyridine or diisopropylethylamine) and in a suitable solvent, such as, for instance, tetrahydrofuran, optionally in the presence of a nucleophilic catalyst. The reaction is carried out at a temperature of from −120° C. to +130° C., preferably from −100° C. to 100° C. Alternatively, the reaction may be conducted in a biphasic system comprising an organic solvent, preferably ethyl acetate, and an aqueous solvent, preferably a saturated solution of sodium bicarbonate.

Compounds of Formula (Ib) may be prepared from a compound of Formula (Ia), under standard conditions, such as treatment with thionyl chloride or oxalyl chloride, in a solvent, such as dichloromethane. The reaction is carried out preferably at a temperature of from −20° C. to +100° C., more preferably from 0° C. to 50° C., in particular at ambient temperature.

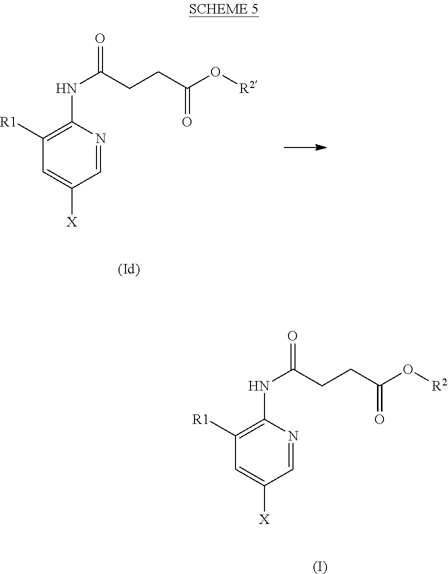

Alternatively, compounds of Formula (I) may be prepared from a compound of Formula (Ib) where in R²′ is a alkyl derivative such as methyl via transesterification in presence of a alcohol derivative (R²OH). Transesterification reactions are well known to a person skilled in the art and where reviewed, for example, in “Synthetic Organic Methodology: Comprehensive Organic Transformations. A Guide to Functional Group Preparations.” Larock, R. C. 1989, p. 985-987, Publisher: (VCH, Weinheim, Fed. Rep. Ger.) or March's Advanced Organic Chemistry: Reactions, Mechanisms, and Structure, 5th Edition, Smith, Michael B.; March, Jerry. UK. 2000, Publisher: (John Wiley & Sons, Ltd., Chichester, UK) p 486-487. Another example, using iron (III). beta.-diketonate species is described in “Transesterification catalyzed by iron (III). beta.-diketonate species.” Weng, Shiue-Shien; Ke, Chih-Shueh; Chen, Fong-Kuang; Lyu, You-Fu; Lin, Guan-Ying. Tetrahedron 2011, 67(9), 1640-1648.

### EXAMPLES

The following HPLC-MS methods were used for the analysis of the compounds A20 to A40:

ACQUITY SQD Mass Spectrometer from Waters (Single quadrupole mass spectrometer)

Ionisation method: Electrospray
Polarity: positive ions

### Capillary (kV) 3.00, Cone (V) 20.00, Extractor (V) 3.00, Source Temperature (° C.) 150, Desolvation Temperature (° C.) 400, Cone Gas Flow (L/Hr) 60, Desolvation Gas Flow (L/Hr) 700

Mass range: 100 to 800 Da
DAD Wavelength range (nm): 210 to 400
Method Waters ACQUITY UPLC with the following HPLC gradient conditions
(Solvent A: Water/Methanol 9:1, 0.1% formic acid and Solvent B: Acetonitrile, 0.1% formic acid)

| Time (minutes) | A (%) | B (%) | Flow rate (ml/min) |
|---|---|---|---|
| 0 | 100 | 0 | 0.75 |
| 2.5 | 0 | 100 | 0.75 |
| 2.8 | 0 | 100 | 0.75 |
| 3.0 | 100 | 0 | 0.75 |

Type of column: Waters ACQUITY UPLC HSS T3; Column length: 30 mm; Internal diameter of column: 2.1 mm; Particle Size: 1.8 micron; Temperature: 60° C.

The following abbreviations are used throughout this section: s=singlet; bs=broad singlet; d=doublet; dd=double doublet; dt=double triplet; t=triplet, tt=triple triplet, q=quartet, m=multiplet; Me=methyl; Et=ethyl; Pr=propyl; Bu=butyl; M.p.=melting point; RT=retention time, MH⁺=molecular cation (i.e. measured molecular weight).

### Synthesis of Final Products:

### Example I

### Synthesis of 4,4,4-trifluorobutyl 4-[(5-bromo-2-pyridyl)amino]-4-oxo-butanoate A1

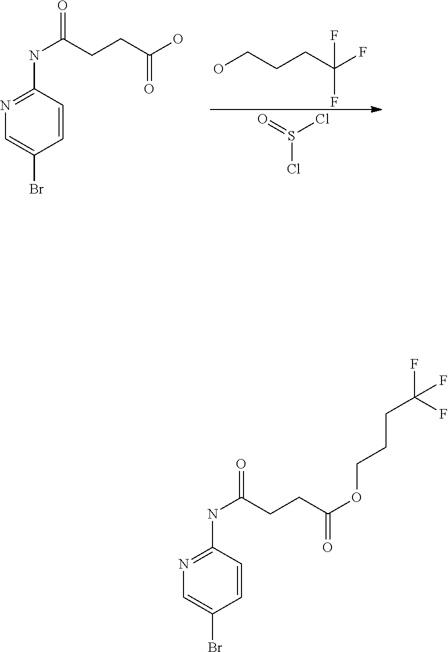

Thionyl chloride (Commercially available, 3 equiv., 2 mmol) was added drop wise to 4,4,4-trifluorobutan-1-ol (2 mL). When the exothermic addition was finish, the reaction was stirred for 5 minutes and 4-[(5-bromo-2-pyridyl)amino]-4-oxo-butanoic acid (Commercially available, 0.2 g, 0.7 mmol) was added. The solution was stirred at 70° C. for 2 hours. The reaction was cooled and quenched by addition of water. The aqeuous layer was extracted with ethyl acetate and washed with a saturated solution of sodium hydrogenocarbonate. After separation, the organic phase was dried and concentrated under vacuum to give 4,4,4-trifluorobutyl 4-[(5-bromo-2-pyridyl)amino]-4-oxo-butanoate A1 (0.22 g, 80%). Mp=118-119° C., ¹H NMR (400 MHz, CDCl₃) δ 8.32 (m, 2H), 8.12 (d, 1H), 7.78 (dd, 1H), 4.20 (m, 2H), 2.74 (m, 4H), 2.20 (m, 2H), 1.92 (m, 2H) ppm.

The compounds A2 to A19 from table A were prepared by the same method using the appropriate alcohol.

### Example II

### Synthesis of but-2-ynyl 4-[(5-bromo-2-pyridyl)amino]-4-oxo-butanoate A20

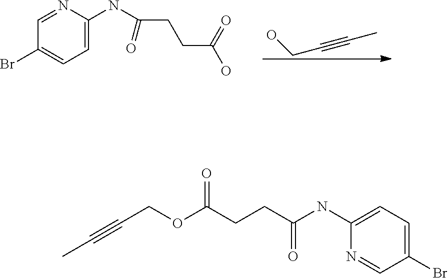

A stock solution of, 4-[(5-bromo-2-pyridyl)amino]-4-oxo-butanoic acid (Commercially available, 560 mg) is prepared in 28.7 mL THF. 0.7 mL of this solution is dispensed into each vial. Then a large excess of alcohol was added and distributed in an Alu24 rack (For the liquid: 0.3 mL, for the solid: 10 eq. dissolved into 0.3 mL THF). In the present example, 0.3 mL of but-2-yn-1-ol was added in a vial. The vials are cooled down to 0° C. and thionylcholoride is added with the multipette (20 uL). The vials are stirred for 20 min at room temperature.

The solvent was evaporated and a mixture of water (2 ML) and ethyl acetate (2 mL) was added. The phases are separated and the aqueous layer was extracted (×2) with ethyl acetate (2 mL). The organic phases were collected and concentrated under vacuum. The samples were dissolved in 0.8 mL of DMF in a 96DPW for the purification. The samples were purified by HPLC and analyse by LC-MS.

The compounds A21 to A40 from table A were prepared, in parallel by the same method using the appropriate alcohol.

### Example III

### Synthesis of 2-(2-methyl-1,3-dioxolan-2-yl)ethyl 4-[(5-bromo-2-pyridyl)amino]-4-oxo-butanoate A43

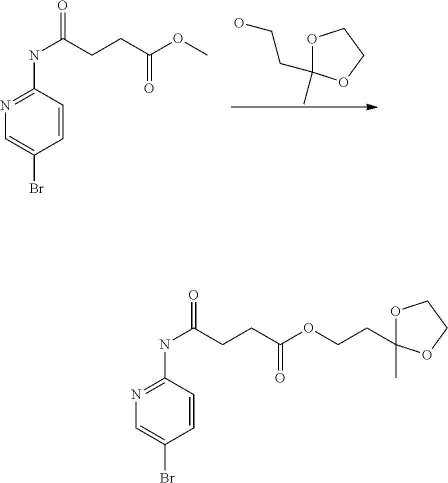

To a 50 mL, three-necked, round-bottomed flask was placed Iron tris(acetoacetonate) (0.1 mmol, 0.1 mmol, 0.05, 0.007 mL), 1,3-dioxolane-2-ethanol, 2-methyl-(2 mL), sodium carbonate (0.1 mmol, 0.004 mL), heptane (20 mL) and methyl 4-[(5-bromo-2-pyridyl)amino]-4-oxo-butanoate (2 mmol) at room temperature under argon atmosphere. The resulting mixture was heated to reflux with the removal of the methanol by Dean-Stark apparatus (filled with 10 mL Heptane) and the reaction progress was monitored by TLC (24 hours). The reaction was colder and quenched by addition of a saturated aqueous NH4Cl solution (10 mL), then extracted with 40 mL ethyl acetate (3×). The combined organic layer was dried (anhydrous MgSO4), filtered, and evaporated to give a crude product (dark brown oil; 1.90 g). The residue was dissolved in EtOH and water was added until the product precipitated. Afterwards the product was filtrated and dried to give 2-(2-methyl-1,3-dioxolan-2-yl)ethyl 4-[(5-bromo-2-pyridyl)amino]-4-oxo-butanoate A43 (0.18 g, 23.5%). Mp=97-98° C.

The compounds A41, A42 and A44 from table A were prepared by the same method using the appropriate alcohol.

TABLE A
Compounds of Formula (I)
(I)

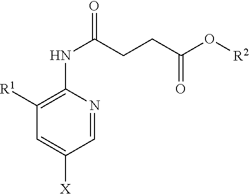

| Compound | X | R¹ | R² | NMR H¹ | | |
|---|---|---|---|---|---|---|
| A1 | Br | H | (CH₂)₃CF₃ | ¹H NMR (400 MHz, CDCl₃) δ 8.32 | | |
| | | | | (m, 2H), 8.12 (d, 1H), 7.78 (dd, 1H), | | |
| | | | | 4.20 (m, 2H), 2.74 (m, 4H), 2.20 (m, | | |
| | | | | 2H), 1.92 (m, 2H) ppm | | |
| A2 | Br | H | (CH₂)₃CH₃ | ¹H NMR (400 MHz, CDCl₃) δ 8. 32 | | |
| | | | | (m, 2H), 8.12 (d, 1H), 7.78 (d, 1H), | | |
| | | | | 4.12 (m, 2H), 2.74 (m, 4H), 1.62 (m, | | |
| | | | | 2H), 1.38 (m, 2H), 0.9 (t, 3H) ppm | | |
| A3 | Br | H | CH(CH₃)(CH₂)₂CH₃ | ¹H NMR (400 MHz, CDCl₃) δ 8.44 | | |
| | | | | (sb, 1H), 8.32 (s, 1H), 8.12 (d, 1H), | | |
| | | | | 7.78 (dd, 1H), 4.95 (m, 1H), 2.72 (m, | | |
| | | | | 4H), 1.30-1.60 (m, 4H), 1.20 (m, 3H), | | |
| | | | | 0.9 (t, 3H) ppm | | |
| A4 | Br | H | CH₂CCH | ¹H NMR (400 MHz, CDCl₃) δ 8.32 (s, | | |
| | | | | 1H), 8.10 (m, 2H), 7.78 (d, 1H), 4.72 | | |
| | | | | (m, 2H), 2.77 (m, 4H), 2.47 (m, 1H). | | |
| A5 | Br | H | CH₂CHCH₂ | ¹H NMR (400 MHz, CDCl₃) δ 8.34 (s, | | |
| | | | | 1H), 8.22 (sb, 1H), 8.12 (d, 1H), 7.78 | | |
| | | | | (d, 1H), 5.91 (m, 1H), 5.29 (m, 2H), | | |
| | | | | 4.62 (m, 2H), 2.75 (m, 4H). | | |
| A6 | Br | H | (CH₂)₂CHCH₂ | ¹H NMR (400 MHz, CDCl₃) δ 8.31 (s, | | |
| | | | | 1H), 8.12 (m, 2H), 7.78 (d, 1H), 5.78 | | |
| | | | | (m, 1H), 5.08 (m, 2H), 4.17 (m, 2H), | | |
| | | | | 2.72 (m, 4H), 2.48 (m, 2H). | | |
| A7 | Br | H | (CH₂)₂SCH₃ | ¹H NMR (400 MHz, CDCl₃) δ 8.38 | | |
| | | | | (sb, 1H), 8.42 (s, 1H), 8.12 (d, 1H), | | |
| | | | | 7.78 (d, 1H), 4.30 (t, 2H), 2.75 (m, | | |
| | | | | 4H), 2.12 (s, CH₃). | | |
| A8 | Br | H | CH₂CF₃ | ¹H NMR (400 MHz, CDCl₃) δ 8.34 (s, | | |
| | | | | 1H), 8.18 (sb, 1H), 8.08 (d, 1H), 7.80 | | |
| | | | | (d, 1H), 4.52 (m, 2H), 2.88 (m, 2H), | | |
| | | | | 2.74 (m, 2H). | | |
| A9 | Br | H | CH₂CHCl₂ | ¹H NMR (400 MHz, CDCl₃) δ 8.32 (s, | | |
| | | | | 1H), 8.12 (d, 1H), 8.04 (sb, 1H), | | |
| | | | | 7.78 (d, 1H), 5.84 (t, 1H), 4.48 (d, | | |
| | | | | 2H), 2.84 (m, 2H), 2.72 (m, 2H). | | |
| A10 | Br | H | (CH₂)₂OCH₃ | ¹H NMR (400 MHz, CDCl₃) δ 8.34 (s, | | |
| | | | | 1H), 8.28 (sb, 1H), 8.12 (d, 1H), 7.78 | | |
| | | | | (d, 1H), 4.28 (m, 2H), 3.60 (m, 2H), | | |
| | | | | 3.38 (s, 3H), 2.80 (m, 2H), 2.68 (m, | | |
| | | | | 2H). | | |
| A11 | Cl | H | (CH₂)₂CHCH₂ | ¹H NMR (400 MHz, CDCl₃) δ 8.20 | | |
| | | | | (m, 3H), 7.64 (dd, 1H), 5.75 (m, 1H), | | |
| | | | | 5.08 (m, 2H), 4.16 (m, 2H), 2.72 (m, | | |
| | | | | 4H), 2.40 (m, 2H). | | |
| A12 | Cl | H | CH₂CHCH₂ | ¹H NMR (400 MHz, CDCl₃) δ 8.18 | | |
| | | | | (m, 3H), 7.63 (dd, 1H), 5.90 (m, 1H), | | |
| | | | | 5.33 (d, 1H), 5.22 (d, 1H), 4.62 (d, | | |
| | | | | 2H), 2.75 (m, 4H). | | |
| A13 | Cl | H | (CH₂)₂OCH₃ | ¹H NMR (400 MHz, CDCl₃) δ 8.51 | | |
| | | | | (sb, 1H), 8.22 (d, 1H), 8.17 (d, 1H), | | |
| | | | | 7.65 (dd, 1H), 4.28 (t, 2H), 3.61 (t, | | |
| | | | | 2H), 2.74 (m, 4H). | | |
| A14 | I | H | CH₂CF₃ | ¹H NMR (400 MHz, CDCl₃) δ 8.38 (s, | | |
| | | | | 1H), 7.95 (m, 3H), 4.44 (m, 2H), 2.72 | | |
| | | | | (m, 4H). | | |
| A15 | Br | H | CH((CH₂)₄) | ¹H NMR (400 MHz, CDCl₃) δ 8.58 | | |
| | | | | (sb, 1H), 8.14 (d, 1H), 7.78 (d, 1H), | | |
| | | | | 5.69 (m, 1H), 2.70 (s, 4H), 1.86-1.65 | | |
| | | | | (m, 8H). | | |
| A16 | Br | H | 1-propyl(4-methylpyrazol) | ¹H NMR (400 MHz, CDCl₃) δ 8.32 (s, | | |
| | | | | 1H), 8.12 (m, 2H), 7.78 (m, 1H), 7.30 | | |
| | | | | (s, 1H), 7.10 (s, 1H), 4.14 (m, 2H), | | |
| | | | | 3.86 (s, 3H), 2.71 (m, 4H), 2.52 (m, | | |
| | | | | 2H), 1.88 (m, 2H). | | |
| A17 | Br | H | CH((CH₂)₃) | ¹H NMR (400 MHz, CDCl₃) δ 8.32 (s, | | |
| | | | | 1H), 8.12 (d, 1H), 8.08 (sb, 1H), 7.78 | | |
| | | | | (d, 1H), 5.01 (m, 1H), 2.70 (m, 4H), | | |
| | | | | 2.34 (m, 2H), 2.08 (m, 2H), 1.80 (m, | | |
| | | | | 1H), 1.62 (m, 1H). | | |
| A18 | Cl | H | CH₂Ph | ¹H NMR (400 MHz, CDCl₃) δ 8.24 (s, | | |
| | | | | 1H), 8.18 (d, 1H), 8.04 (sb, 1H), 7.64 | | |
| | | | | (m, 1H), 7.32-7.25 (m, 5H), 5.14 (s, | | |
| | | | | 2H), 2.82-2.70 (m, 4H) | | |
| A19 | Br | H | CH₂Ph | ¹H NMR (400 MHz, CDCl₃) δ 8.32 (s, | | |
| | | | | 1H), 8.12 (d, 1H), 8.04 (sb, 1H), 7.78 | | |
| | | | | (m, 1H), 7.32-7.25 (m, 5H), 5.04 (s, | | |
| | | | | 2H), 2.82-2.68 (m, 4H) | | |
| | | | | | M | (M + H)+ |
| | X | R1 | R2 | RT | (calculated) | (measured) |
| A20 | Br | H | CH₂CCCH₃ | 1.31 | 324.01 | 325.16 |
| A21 | Br | H | (CH₂)₂Ph | 1.60 | 376.04 | 377.21 |
| A22 | Br | H | CH₂CH(CH₂OCH₂CH₂) | 1.15 | 356.03 | 357.20 |
| A23 | Br | H | CH₂CHCH(CH₂) | 1.83 | 368.07 | 369.24 |
| A24 | Br | H | CH₂CH₂CCCH₂CH₃ | 1.45 | 352.04 | 353.20 |
| A25 | Br | H | CH₂CH₂C(O)OCH₂CH₂OCH(CH₃)₂ | 1.35 | 358.05 | 359.21 |
| A26 | Br | H | CH(CH₂CH₂OCH₂CH₂) | 1.16 | 356.03 | 357.19 |
| A27 | Br | H | CH₂CH₂CCC(CH₃)₃ | 1.77 | 380.07 | 381.24 |
| A28 | Br | H | CH₂CH₂S(O)₂CH₃ | 0.94 | 377.98 | 379.16 |
| A29 | Br | H | CH(CH₂OCH₂CH₂) | 1.08 | 342.02 | 343.18 |
| A30 | Br | H | CH₂CH₂Br | 1.31 | 377.92 | 379.08 |
| A31 | Br | H | CH(CH₂CH₂C((H)(CH₃)₃)CH₂CH₂) | 2.09 | 410.12 | 411.29 |
| A32 | Br | H | CH(CH₂CH₂C((H)(CH₂CH₃))CH₂CH₂) | 1.91 | 382.08 | 383.35 |
| A33 | Br | H | CH₂CH₂SCH₂CH₃ | 1.44 | 360.01 | 361.18 |
| A34 | Br | H | CH(CH₂CH₂CH₂CH₂CH₂) | 1.64 | 354.05 | 355.23 |
| A35 | Br | H | CH₂CH₂SCH(CH₃)₂ | 1.56 | 374.02 | 375.21 |
| A36 | Br | H | CH₂(3-CF₃Ph) | 1.71 | 430.01 | 431.22 |
| A37 | Br | H | CH₂(4-OCF₃Ph) | 1.76 | 446.00 | 447.21 |
| A38 | Br | H | CH(CH₂SCH₂CH₂) | 1.33 | 357.99 | 359.30 |
| A39 | Br | H | CH₂CHC(CH₃)₂ | 1.53 | 340.04 | 341.20 |
| A40 | Br | H | CH₂CH(SCH₂CH₂S) | 1.41 | 389.97 | 391.16 |

| Compound | X | R1 | R2 | NMR H¹ |
|---|---|---|---|---|
| A41 | Br | H | (CH₂)₃(2-Pyridyl) | ¹H NMR (400 MHz, CDCl₃) δ 8.52 (s, |
| | | | | 1H), 8.32 (s, 1H), 8.18 (sb, 1H), |
| | | | | 8.12(d, 1H), 7.78 (d, 1H), 7.58(m, |
| | | | | 1H), 7.12(m, 2H), 4.18 (m, 2H), 3.28 |
| | | | | (m, 2H), 2.72 (m, 4H), 2.10 (m, 2H). |
| A42 | Br | H | CH₂(2,5-(CH₃O)₂Ph) | ¹H NMR (400 MHz, CDCl₃) δ 8.31 (s, |
| | | | | 1H), 8.12 (sb, 1H), 8.10 (d, 1H), 7.78 |
| | | | | (d, 1H), 6.90 (s, 1H), 6.80 (m, 2H), |
| | | | | 5.18 (s, 2H), 3.78(s, 3H), 3.76 (s, 3H), |
| | | | | 2.82 (m, 2H), 2.72 (m, 2H). |
| A43 | Br | H | CH₂CH₂C((CH₃)(O(CH₂)₂O)) | ¹H NMR (400 MHz, CDCl₃) δ 8.33 (s, |
| | | | | 1H), 8.24 (sb, 1H), 8.11 (d, 1H), |
| | | | | 7.78(d, 1H), 4.24 (t, 2H), 3.93 (m, |
| | | | | 4H), 2.72 (m, 4H), 2.02(t, 2H), 1.33 |
| | | | | (s, 3H). |
| A44 | Br | H | CH₂(6-CH₃-Pyridyl-2) | ¹H NMR (400 MHz, CDCl₃) δ 8.30 (s, |
| | | | | 1H), 8.12 (m, 2H), 7.78 (d, 1H), |
| | | | | 7.75 (t, 1H), 7.15 (d, 1H), 7.08 (d, 1H), |
| | | | | 5.22 (s, 2H), 2.88 (m, 2H), 2.74 (m, |
| | | | | 2H), 2.53 (s, 3H). |

### BIOLOGICAL EXAMPLES

Two bioassays were developed in order to assay the activity of the compounds of the present invention. In the first assay, the activity of the compound was quantified in beans based on its effect on the elongation of the petiole of the second leaf. In the second assay, the compound's effect on the root growth of wheat was determined.

### Example B1

### Bean Assay

French beans (Phaseolus vulgaris) of the variety Fulvio were sown in 0.5 litres pots in a sandy loam without additional fertilizer. Plants grew under greenhouse conditions at 22/18° C. (day/night) and 80% relative humility; light was supplemented above 25 kLux. Plants were treated with test compounds eleven days after sowing, when the second internode was 2-5 mm long. Before application, the compounds were each dissolved in dimethyl sulfoxide and diluted in a mixture of water and ethanol (1:1 ratio by volume). Five micro litres of the test compound was pipetted to the wound that was created after abscising the bract leaf from the base of the second internode. Fourteen days after application, the length of the petiole of the second leaf (measured from the base of the petiole to the base of the first leaflet) was determined in order to quantify the activity of the compounds.

The following compounds gave at least an increase of 5% of the length of the petiole of the second leaf:

### A4, A6, A8, A9, A10, A13, A16, A22.

### Example B2

### Wheat Assay

The test compounds were dissolved in small volumes of dimethyl sulfoxide and diluted to the appropriate concentration with water. Wheat (Triticum aestivum) seeds of the variety Arina were sown in mini-pouches (10.5×9.0 cm) containing 5 ml of the appropriate compound solution. The mini pouches were stored at 17° C. for three days to enable the seeds to germinate. Plants were then stored at 5° C. Twelve days after sowing/application, plants were removed from the mini-pouches and scanned. The effect of the compounds was quantified by determining plant (root and shoot) area and curliness of the roots (curliness is an indicator of brassinosteroid-type activity).

The following compound gave at least a reduction of 15% of the plant (root and shoot) area and showed a curly root phenotype:

A4, A5, A8, A9, A10, A12, A13.

1. A compound of Formula (I) 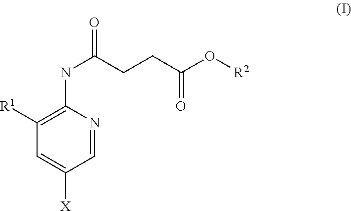
wherein
R¹ is H, C₁-C₂alkyl, C₂alkyl substituted by one or more halogen, hydroxyl or amine;
X is halogen,
R² is C₄-C₉alkyl; C₄-C₉alkyl substituted by one or more halogen, hydroxyl or amine;
methyl substituted by one or more halogen; C₂-C₃alkyl substituted by more than two halogens; C₁-C₉alkyl substituted by one or more of the following: cyano, nitro, C₁-C₆alkoxy, C₁-C₆haloalkoxy, C₁-C₆alkylthio, C₁-C₆haloalkylthio, C₁-C₆alkylsulfinyl, C₁-C₆haloalkylsulfinyl, C₁-C₆alkylsulfonyl, C₁-C₆haloalkyl-sulfonyl, C₂-C₆alkenyl, C₂-C₆haloalkenyl, C₂-C₆alkynyl, C₂-C₆haloalkynyl, C₃-C₆cycloalkyl, C₄-C₆alkylcycloalkyl, aryl, aryl substituted by one to five substituents R³, heteroaryl, heteroaryl substituted by one to five substituents R³, heterocyclyl, or heterocyclyl substituted by one to five substituents R³; C₃-C₇cycloalkyl or C₃-C₇cycloalkyl substituted by one to five substituents R⁴; aryl or aryl substituted by one to five substituents R³; heteroaryl or heteroaryl substituted by one to five substituents R³; or heterocyclyl or heterocyclyl substituted by one to five substituents R³;
each R³ is independently cyano, nitro, amino, hydroxy, halogen, C₁-C₆alkyl, C₁-C₆haloalkyl, C₁-C₄alkoxy-C₁-C₄-alkyl, C₂-C₆alkenyl, C₂-C₆haloalkenyl, C₂-C₆alkynyl, C₂-C₆haloalkynyl, C₃-C₆cycloalkyl, C₃-C₆halocycloalkyl, C₁-C₆alkoxy, C₁-C₆haloalkoxy, C₁-C₄alkoxy-C₁-C₄-alkoxy, C₁-C₆alkylthio, C₁-C₆haloalkylthio, C₁-C₆alkylsulfinyl, C₁-C₆haloalkylsulfinyl, C₁-C₆alkylsulfonyl, C₁-C₆haloalkyl-sulfonyl, N—C₁-C₆alkylamino, N,N-di-(C₁-C₆alkyl)amino, N,N-di-(C₁-C₆alkyl)-aminocarbonyl, N,N-di-(C₁-C₆alkyl)aminosulfonyl, C₁-C₆alkylcarbonyl, C₁-C₆alkyl-carbonyloxy, C₁-C₆alkoxycarbonyl, or C₁-C₆alkylcarbonylamino; and
each R⁴ is independently cyano, halogen, C₁-C₄alkyl, C₁-C₄haloalkyl, C₁-C₄alkoxy, or C₁-C₄alkylthio;
or salts or N-oxides thereof.

2. A compound according to claim 1, wherein
R¹ is H, or methyl;
X is Cl, Br or I;
R² is C₄-C₉alkyl;
C₄-C₉alkyl substituted by one or more halogen, hydroxyl or amine;
or C₁-C₉alkyl substituted by one or more of the following: cyano, C₁-C₆alkoxy, C₁-C₆alkylthio, C₂-C₆ alkenyl, C₂-C₆alkynyl, C₁-C₆alkylsulfinyl, C₁-C₆alkylsulfonyl, C₃-C₆cycloalkyl, C₄-C₆alkylcycloalkyl, aryl, aryl substituted by one to five substituents R³, heteroaryl, heteroaryl substituted by one to five substituents R³, heterocyclyl, or heterocyclyl substituted by one to five substituents R³; and
each R³ is independently cyano, nitro, amino, hydroxy, halogen, C₁-C₆alkyl, C₁-C₆haloalkyl, C₁-C₄alkoxy-C₁-C₄-alkyl, C₂-C₆alkenyl, C₂-C₆haloalkenyl, C₂-C₆alkynyl, C₂-C₆haloalkynyl, C₃-C₆cycloalkyl, C₃-C₆halocycloalkyl, C₁-C₆alkoxy, C₁-C₆haloalkoxy, C₁-C₄alkoxy-C₁-C₄-alkoxy, C₁-C₆alkylthio, C₁-C₆haloalkylthio, C₁-C₆alkylsulfinyl, C₁-C₆haloalkylsulfinyl, C₁-C₆alkylsulfonyl, C₁-C₆haloalkyl-sulfonyl, N—C₁-C₆alkylamino, N,N-di-(C₁-C₆alkyl)amino, N,N-di-(C₁-C₆alkyl)-aminocarbonyl, N,N-di-(C₁-C₆alkyl)aminosulfonyl, C₁-C₆alkylcarbonyl, C₁-C₆alkyl-carbonyloxy, C₁-C₆alkoxycarbonyl, or C₁-C₆alkylcarbonylamino.

3. A compound according to claim 1, wherein R² is C₄-C₉alkyl; C₄-C₉alkyl substituted by one or more halogen, hydroxyl or amine; or C₁-C₉alkyl substituted by C₁-C₆alkoxy, C₁-C₆alkylthio, C₂-C₆ alkenyl, or C₂-C₆alkynyl.

4. A plant growth regulator or seed germination promoting composition, comprising a compound according to claim 1, and an agriculturally acceptable Formulation adjuvant.

5. A method for regulating the growth of plants at a locus, wherein the method comprises applying to the locus a plant growth regulating amount of a compound according to claim 1.

6. A method for promoting the germination of seeds comprising applying to the seeds, or a locus containing seeds, a seed germination promoting amount of a compound according to claim 1.

7. A method for controlling weeds comprising applying to a locus containing the seeds a seed germination promoting amount of a compound according to claim 1, allowing the seeds to germinate, and then applying to the locus a post-emergence herbicide.

8. (canceled)
